(19) United States
(12) Patent Application Publication
(10) Pub. No.: US 2022/0228398 A1
(43) Pub. Date: Jul. 21, 2022

(54) System and Method for Integrating Key Access Control of Legacy Lockable Articles into a Control System and Associated Lock Boxes

(71) Applicant: Raytheon Company, Waltham, MA (US)

(72) Inventor: Joseph E. Grella, Shrewsbury, MA (US)

(73) Assignee: Raytheon Company

(21) Appl. No.: 17/152,652

(22) Filed: Jan. 19, 2021

(51) Int. Cl. E05B 19/00; G05B 19/05; G07C 9/00; E05B 41/00; E05B 47/00; G16Y 10/75

(52) U.S. Cl. CPC E05B 19/0005; G05B 19/054; G07C 9/00817; E05B 2047/0067; E05B 47/0001; G16Y 10/75; G05B 2219/1101; E05B 41/00

(57) ABSTRACT

The present disclosure sets forth a system for integrating key access control of a plurality of legacy lockable articles into a tool control system. The system can comprise a plurality of lock boxes each associated with a respective legacy lockable article. Each of the plurality of lock boxes can be configured to selectively lock and unlock access to a key operable to facilitate access to the respective legacy lockable article. The system can further comprise a programmable logic controller communicatively coupled to each of the plurality of lock boxes. The programmable logic controller can be operable to send control instructions to the plurality of lock boxes to lock or unlock access to the key.

### BACKGROUND

In many types of industries, it is important to be able to control tools, chemicals, and other items used in industrial processes. The ability to control such tools and consumables can be referred to generally as tool control. With enhances in technology, much of tool control can be tracked using electronic or computer-implemented systems.

However, even with such electronic systems in place, there can often still be tools that are not directly linked to such systems. For example, standard tool boxes, chemical cabinets, closets, or other such articles (hereinafter referred to as “legacy lockable articles”) can still store tools or other consumables used in many industrial applications. Tools stored in such legacy lockable articles are not part of more modern tool control systems. For instance, a tool from a legacy tool box can often only be checked out and checked in manually or via a dedicated system.

Such legacy lockable articles typically are locked and unlocked with a dedicated key. Access to such key is tracked manually, and thus there is little to no practical regulation over access to the key or to the contents stored in the legacy lockable article locked by the key. For example, access to a key could be tracked via an in/out log stored on paper or electronically. The regulation of the key access in this instance is only as good as the adherence of those following the tracking policy. Often, once an article is unlocked, anyone has access to the contents.

The results of such systems can lead to tools being damaged, misplaced, or lost. This can also lead to quality control issues for toolbox contamination. In some applications, the importance of preventing the presence foreign objects or debris (“FOD”) leads to the necessary assumption that the missing tool is FOD in a product until proven otherwise, which can be a costly endeavor. Thus, this lack of accountability can result in significant downtime and utilization of additional resources to locate or replace tools.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 is a schematic diagram of an exemplary system for integrating legacy lockable articles into a tool control system.

FIG. 2 is a front, left isometric view of an exemplary tamper proof lockbox for incorporation into the system shown in FIG. 1

FIG. 3 is a rear, right isometric view of the tamper proof lockbox of FIG. 2.

FIG. 4 is a front, right isometric view of the tamper proof lockbox of FIG. 2 with a front panel removed.

Reference will now be made to the exemplary embodiments illustrated, and specific language will be used herein to describe the same. It will nevertheless be understood that no limitation of the scope of the invention is thereby intended.

### DETAILED DESCRIPTION

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

An initial overview of the inventive concepts are provided below and then specific examples are described in further detail later. This initial summary is intended to aid readers in understanding the examples more quickly, but is not intended to identify key features or essential features of the examples, nor is it intended to limit the scope of the claimed subject matter.

The present disclosure sets forth a system for integrating key access control of a plurality of legacy lockable articles into a tool control system. The system can comprise a plurality of lock boxes each associated with a respective legacy lockable article. Each of the plurality of lock boxes can be configured to selectively lock and unlock access to a key operable to facilitate access to the respective legacy lockable article. The system can further comprise a programmable logic controller communicatively coupled to each of the plurality of lock boxes. The programmable logic controller can be operable to send control instructions to the plurality of lock boxes to lock or unlock access to the key.

The system can further comprise a human machine interface communicatively coupled to the programmable logic controller. The human machine interface can be in communication with one or more processors and a memory, and can be operable to receive user instructions to lock or unlock the one or more lock boxes. The system can further comprise an internet of things server (as part of an internet of things infrastructure) communicatively coupled to the programmable logic controller and the human machine interface. The internet of things server can be configured to receive an unlock or locked status for each of the one or more lockboxes from the programmable logic controller and to send unlock or lock commands to the programmable logic controller based on one or more predetermined conditions.

In one example, each of the plurality of lock boxes can comprise a lock box body comprising a mount to attach the lock box body to the respective legacy lockable article. The mount can be accessible from inside a locked portion of the legacy lockable article. Each of the plurality of lock boxes can comprise a key holder comprising a key interface for securing a key to the key holder, and a lock interface for facilitating locking of the key holder to the lock box body.

In some examples, each of the plurality of lock boxes can comprise an access opening in the lock box body configured to receive the key holder. The lock boxes can further comprise an actuatable lock disposed within the lock box body operable to interface with the lock interface of the key holder to lock the key holder to the lock box body based on the control instructions received from the programmable logic controller.

In one exemplary embodiment, a tamper proof lock box is provided. The tamper proof lock box can comprise a lock box body comprising a mount to attach the lock box body to an external structure. The lock box can further comprise a data port disposed on the lock box body. The data port can be communicatively coupled to a programmable logic controller. The lock box can comprise a key holder comprising a key interface for securing a key to the key holder, and a lock interface for facilitating locking of the key holder to the lock box body. The lock box can further comprise an access opening configured to receive the key holder, and an actuatable lock disposed within the lock box body. The actuatable lock can be operable to interface with the lock interface of the key holder to lock the key holder to the lock box body.

In some examples, the actuatable lock can comprise a linear actuator operable to interface with the lock interface of the key holder to lock the key holder to the lock box body. The lock interface can comprise an aperture, and the linear actuator can comprise comprises shaft that extends through the aperture to lock the key holder to the lock box body. The access opening can comprise a slot in the lock box body, and the linear actuator can be oriented substantially perpendicular to the slot.

In some examples, the tamper proof lock box can comprise a key sensor operable to detect the presence of the key holder at the lock box. The key sensor can comprise an inductive proximity sensor. The lock box can further comprise one or more visual indicators disposed on the lock box body. The one or more visual indicators can be operable to communicate a status of the key holder. The one or more visual indicators can comprise LEDs.

In one example, a method for integrating key access control of a plurality of legacy lockable articles in a tool control system is provided. The method can comprise providing a plurality of lock boxes each associated with a respective legacy lockable article. Each of the plurality of lock boxes can be configured to selectively lock and unlock access to a key operable to facilitate access to the respective legacy lockable article. The method can further comprise receiving a lock/unlock status from the plurality of lock boxes at a programmable logic controller communicatively coupled to each of the plurality of lock boxes.

The method can comprise sending a lock/unlock status from the programmable logic controller to an internet of things server communicatively coupled with the programmable logic controller, and receiving control instructions at a human machine interface communicatively coupled to the internet of things server to lock or unlock access to the key at a first lock box of the plurality of lock boxes and sending the control instructions to the internet of things server. The method can further comprise validating the control instructions at the internet of things server and sending the control instructions to the programmable logic controller and sending a lock or unlock command from the programmable logic controller based on the control instructions to the first lock box.

In some examples, the method can further comprise receiving a first indication at the programmable logic controller that the key is removed from the lock box based on an output from a key sensor of the first lock box, receiving a second indication at the programmable logic controller that the key is returned to the lock box based on the output from the key sensor of the first lock box, and receiving a third indication at the programmable logic controller that the key is removed from the lock box for a predetermined time period.

In some examples, the method can further comprise displaying a key status at the lock box based on the first, second, and third indications via one or more visual indicators. The method can also comprise attaching the key to a key holder. The plurality of lock boxes can be configured to selectively lock and unlock the key holder. The plurality of lock boxes can selectively lock and unlock the key holder via a linear actuator disposed at each of the plurality of lock boxes. The linear actuator can lock the key holder to the lock box via a shaft that extends through a corresponding aperture of the key holder.

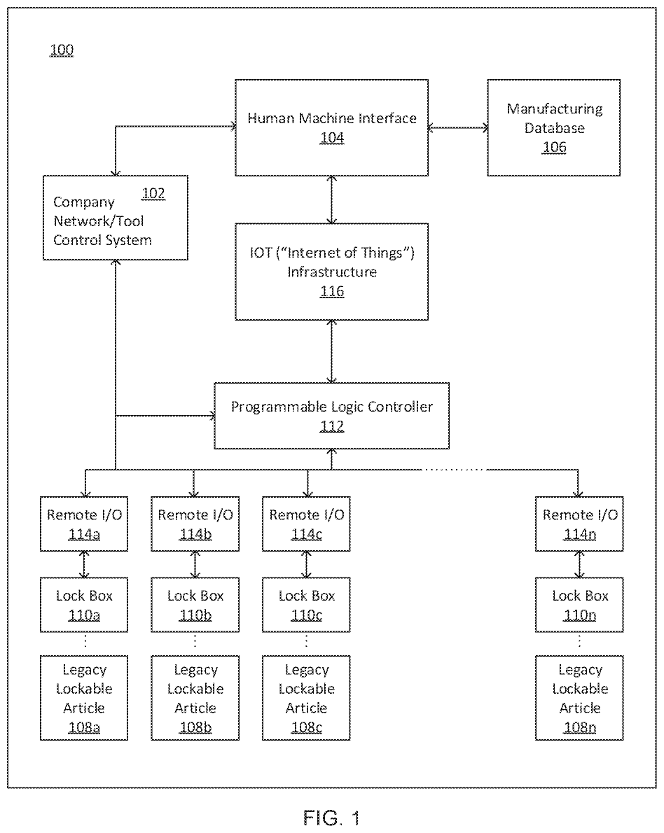

To further describe the present technology, examples are now provided with reference to the figures. With reference to FIG. 1, a system is set forth for integrating key access to a legacy lockable article into a tool control system. A tool control system as referred to herein is a computer or electronically implemented system for tracking the use of tools, chemicals, or other objects or substances to be used during a procedure that can be locked within a toolbox, cabinet, closet or other lockable article (hereinafter “lockable article”). In FIG. 1, a system 100 can comprise a company network 102. The company network 102 can comprise a plurality of computing devices such as servers, personal work stations, and other devices that are networked together over a wired or wireless network. The company network 102 can comprise security networks and protocols to authenticate access to the network to ensure that only authorized users access the network. Thus the company network 102 can be used to manage a plurality of user profiles including authentication information and user access rights for each profile. In some examples, the company network 102 can host and facilitate a tool control system. The network 102 can be established according to any desired network protocol now known or later developed. Such networks can include, but are not limited to, one or more of a LAN, WLAN, WAN or the like.

The system 100 can further comprise one or more human machine interfaces 104. The human machine interface 104 can be, for example, a personal computing workstation connected to the company network 102. The human machine interface 104 can also be any one of a kiosk, mobile device, or other device that comprises an input device for receiving instructions from a user (such as a keyboard, mouse, microphone, card reader, touchscreen, etc.) and an output device to provide feedback to a user (such as a monitor, printer, speaker, etc.). The human machine interface 104 allows the user to interact with the system 100, such as to log in to the company network 102, provide instructions to the system 100, or to obtain a status of one or more devices in the system 100, as will be explained in further detail below.

The system further comprises a manufacturing database 106. The manufacturing database 106 can comprise a memory storing manufacturing information such as process flows for manufacturing processes and documenting completed processes including associated tools and consumable used during such processes. The manufacturing database 106 can be connected to the one or more human machine interfaces 104.

The system further comprises a plurality of legacy lockable articles (e.g., see legacy lockable articles 108a, 108b, 108c and 108n, referred to generally and/or collectively as legacy lockable articles 108). In this example, there can be any desired number of legacy lockable articles 108 as designated in FIG. 1 and represented by legacy lockable articles 108a, 108b, 108c through 108n, with “n” representing any number of such articles. The legacy lockable articles 108 can comprise any type of lockable storage articles, such as a tool box, a storage cabinet, a storage closet, or the like. The legacy lockable articles 108 can be locked via a key. For example, the legacy lockable articles 108 can comprise one or more doors, drawers, boxes, etc. that are lockable via a lock and a corresponding key. By “legacy” it is meant that the legacy lockable articles 108 are not directly connectable to any network device, and are not part of a network tool control system prior to being part of the system described herein. Thus, standing alone and outside of being part of the system described herein, the legacy lockable articles 108 are not capable of being controlled via a tool control system hosted by, for example, the company network 102.

Advantageously, to integrate key access of the legacy lockable articles 108 to a tool control system, the system 100 described herein comprises a plurality of lock boxes 110. As shown in FIG. 1, each of a plurality of lock boxes 110a, 110b, 110c through 110n (hereinafter referred to generally and/or collectively as lock boxes 110) can correspond to a respective legacy lockable article 108a, 108b, 108c through 108n. The plurality of lock boxes 110 are operable to lock a key associated with a respective legacy lockable article 108. Unlike the legacy lockable articles 108, the plurality of lock boxes 110 are configured to communicatively couple to other networked components of the system 100, and thus are operable to integrate into a tool control system, such as one hosted by the company network 102. By doing so, the associated legacy lockable articles 108 are integrated into the tool control system, and are able to be managed via the tool control system along with other lockable articles already a part of the tool control system.

The plurality of lock boxes are connected to a programmable logic controller 112. The programmable logic controller (“PLC”) 112 comprises one or more memories and a processor and is configured to provide control instructions to each of the lock boxes 110. In some examples, the PLC 112 sends control instructions to the lock boxes 110 via a plurality of respective remote input/output (“I/O”) devices 114a, 114b, 114c through 114n (hereinafter referred to generally and/or collectively as remote I/O devices 114). The remote I/O devices 114 can comprise a digital to analog converter to convert digital control instructions from the PLC 112 to analog signals to control respective lock boxes 110. In some examples, the remote I/O devices 114 can be omitted and the signals can be sent directly to the lock boxes 110 where the lock boxes comprise an internal digital to analog converter or otherwise operate independent of the remote I/O devices 114.

The PLC 112 can be connected to an Internet of Things (“IOT”) infrastructure 116. The IOT infrastructure 116 can comprise a plurality of servers and networked connected devices, sensors, and other instruments. In some examples, the IOT infrastructure 116 can be an industrial IOT infrastructure 116. The IOT infrastructure 116 can be utilized to track a status of devices connected as part of the IOT infrastructure 116 and to provide control instructions to connected devices based on one or more preprogrammed conditions or based on instructions received from a user. For example, the IOT infrastructure 116 can receive status information from the PLC 112 concerning a locked or unlocked state of each lock box 110, or the presence or absence of a key from a lock box 110, and provide output to the human machine interface 104 based on the status received. The IOT infrastructure 116 can also relay control instructions entered at a human machine interface 104 to one or more of the lock boxes 110 via the PLC 112.

Thus, the system 100 facilitates integration of key control access of legacy lockable articles 108 into a tool management and control system such as one hosted by a company network 102. For example, the system 100 allows integration of a user request to utilize substances or tools in a legacy lockable article 108 by controlling access to a lock box 110 and key associated with the lock box 110 and the legacy lockable article 108. Furthermore, because the system 100 connects together key control of legacy lockable articles 108 with a company network 102, events at a lock box 110 associated with a legacy lockable article 108 can be associated with specific users of a company network 102 or with specific processes outlined by processes stored in a manufacturing database.

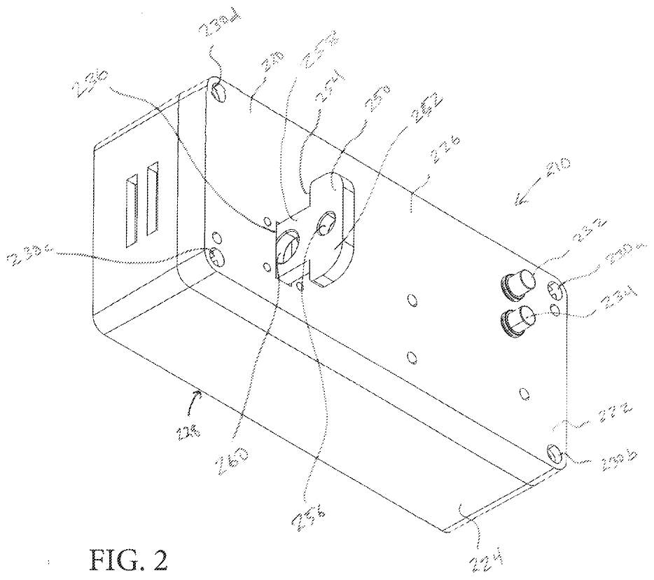

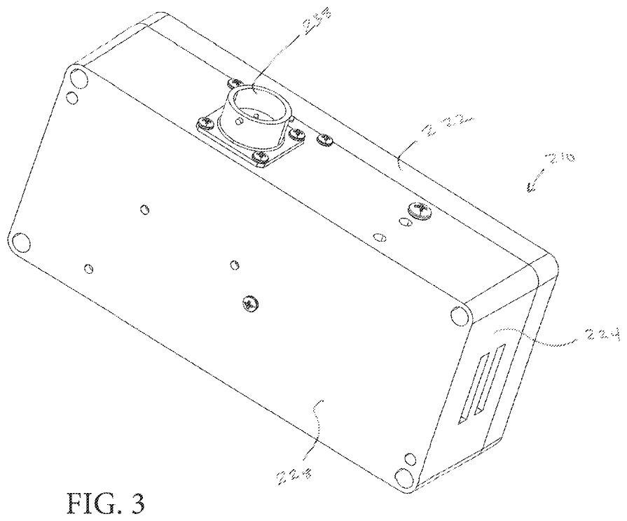

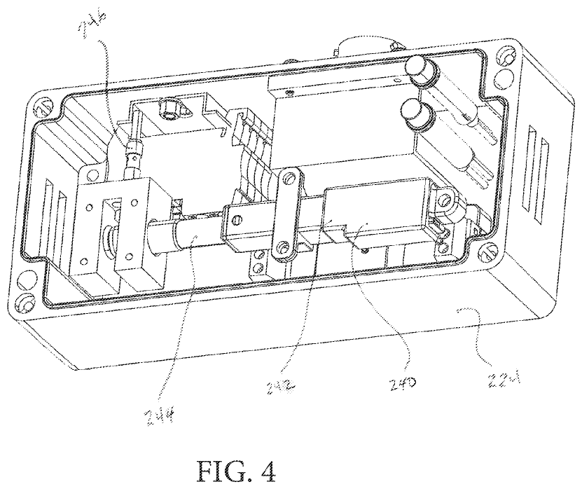

As mentioned above, the plurality of lock boxes 110 are utilized to facilitate key access control to the legacy lockable articles 108 via the tool control system, thus integrating the plurality of lock boxes 110 with the tool control system. FIGS. 2-4 show an exemplary lock box for use with the system 100. As shown in FIGS. 2-4 a lock box 210 (similar to lockbox 110 from FIG. 1) can comprise a lock box body 220. The lock box body 220 comprises a tamper proof structure to securely house the components of the lock box 210 and to secure the lock box 210 with respect to a legacy lockable article (such as legacy lockable article 108 from FIG. 1).

The lock box body 220 can comprise a main portion 224 and a cover 222. The cover 222 can be secured to the main portion 224 in any suitably secure manner including adhesives, fasteners, welding, or the like. The cover 222 and main portion 224 can be formed from durable materials, such as steel or other metals, and suitably sized and configured to prevent tampering. An outer surface of the cover 222 defines a front surface 226 of the lock box 210. The main portion 224 comprises a back surface 228 of the lock box 210.

The lock box body 220 is configured to be associated with a legacy lockable article, such as securely mounted to a legacy lockable article. In some examples, the lock box body 220 can be mounted to the legacy lockable article. For example, the lock box body 220 can be mounted to the legacy lockable article such that the mount or mounting hardware is only accessible from within a locked area or compartment of the legacy lockable article. Thus, the mount or mounting hardware is not accessible without access to the key, increasing the security of the lock box 210. In this example, the lock box body can comprise mounting apertures 230a, 230b, 230c, 230d that extend from the front surface 226 to the back surface 228. The mounting apertures 230a, 230b, 230c, 230d can facilitate the mounting of the lock box body 220, such that the back surface 228 abuts against the legacy lockable article and the mount or mounting hardware is accessible only from within the legacy lockable article. Of course, other mounting methods including permanent and removable mountings can be utilized without limitation.

The lock box 210 can comprise visual indicators 232, 234 that provide feedback to a user concerning a status of the lockbox 210. The visual indicators 232, 234 can be disposed on the front surface 226 of the lock box 210. The visual indicators 232, 234 can be LEDs that light based upon a predetermined condition of the lock box 210. For example, the visual indicator 232 can be an LED indicator that lights based on a locked or an unlocked condition of the lock box 210. The visual indicator 234 can be an LED indicator that lights based on the presence or absence of a key at the lock box 210. These visual indicators 232, 234 can be part of an internal electronics system (comprising various electronics components, such as circuitry and circuit components, sensors, batteries, switches, etc.) supported by the lock box 210.

The lock box 210 can further comprise an access opening 236 disposed on or otherwise formed in the lockbox body 220. As shown in this example, the access opening 236 can comprise a slot formed in the cover 222 extending from the front surface 226 of the lockbox body 220 through the cover 222. The access opening 266 can be sized and configured to receive therein an inserted key or key holder to facilitate the key or key holder being locked by the lock box 210 as will be described below.

The lockbox body 220 can comprise a data/power port 238, such as the data/power port 238 shown that is disposed or supported on the main portion 224. The data/power port 238 can communicatively connect to a data/power source via one or more wires, cables or other type of data/power carriers that facilitate the transfer of power to the lock box 210 and the transfer of data to and from the lock box 210 (such as the transfer of control instructions from the PLC 112 in FIG. 1 to the lock box 110 and the transfer of a status of the lock box 110 to the PLC 112). The data/power port 238 can be communicatively coupled to the internal electronics of the lockbox 210.

The lock box 210 can comprise an actuatable lock 240 to lock a key or key holder to the lock box body 220. As shown in this example, the actuatable lock 240 can comprise a linear actuator having a motor 240 and a shaft 244. Upon actuation, the actuatable lock 240 can activate the motor 240 to extend the shaft 244 to engage or interface with a key or key holder to lock the key or key holder to the lock box body 220. The actuatable lock 240 can also be controlled to unlock a key or key holder by retracting the shaft 244 from the key or key holder, thereby releasing it from the lock box body 220. The shaft 244 can be disposed within the main portion 224 so as to be transverse (e.g., substantially perpendicular) to the slot defining the access opening 236 of the lock box body 220. This facilitates the shaft 244 to easily interface with and lock the key holder as described in more detail below.

The lock box 210 can comprise a key sensor 246. The key sensor 246 can comprise an inductive proximity sensor to sense the presence of a key or a key holder at the lock box 210. As mentioned above, the visual indicators 232, 234 can be configured to light based on the status of the actuatable lock 240 and the key sensor 246.

The lock box 210 can comprise a corresponding key holder 250 that is operable to interface with the lock box 210. In one example, the key holder 250 can comprise a head portion 252 having flanges 254. The flanges 254 form a stop by interfacing with the front surface 226 of the lock box 250 upon the key holder 250 being inserted a distance into the access opening 236. Indeed, when the key holder 250 is inserted into the access opening 236 the key holder 250 moves into the access opening 236 until the flanges 254 of the head portion 252 abut the front surface 226 of the lock box 210. This aligns the key holder 250 for locking. The head portion 252 further comprises a key interface 256. In one example, as shown, the key interface 256 can comprise a key aperture facilitating attachment of a key to the key holder 250, wherein the key is operable to lock and unlock the associated legacy lockable article. In one example, the key can be attached or tethered to the key holder 250 via a tamper proof cable or other tethering structure or device that is inserted through the key aperture of the key holder 250 and secured to itself, such as via a cable lock or more permanent fixture (e.g., a cable connector, crimping sleeve, and others). In this way, the key can be fixed to and caused to be inseparable from the key holder 250. Of course, less tamperproof and less permanent methods are contemplated (e.g., securing the key to the key holder 250 via a zip tie, rope, or other less tamperproof solution), but these may be less desirable.

The key holder 250 can further comprise a locking portion 258 that comprises a lock interface 260. The lock interface 260 can be defined by a cylindrical aperture formed in the locking portion 258 that is operable to receive the shaft 244 of the actuatable lock 240 to selectively lock and unlock the key holder 250 to the lock box body 220. For example, when the key holder 250 is inserted into the access opening 236 and the flanges 254 seat against the front surface 226 of the lock box 210, the lock interface 260 defined by the cylindrical aperture aligns with the shaft 244 of the actuatable lock 240. In this position, the shaft 244 can be actuated by the motor 240 to move the shaft 244 into engagement with the lock interface 260 to lock the key holder 250 to the lock box body 220. The actuatable lock 240 can be actuated based on a lock command received from a PLC (such as PLC 112 via remote I/O 114 as shown in FIG. 1). The lock command from a PLC can be initiated via user request generated via a manual input at a human machine interface (such as human machine interface 104 in FIG. 1) requesting access to the key associated with the key holder 250 and lock box 210. The lock command from the PLC can also be initiated autonomously based on one or more predetermined conditions such as via information from a manufacturing database (such as manufacturing database 106 of FIG. 1) pertaining to a process or a step in a process, and/or via preprogrammed conditions monitored in an IOT infrastructure (such as IOT infrastructure 116 of FIG. 1) or tool control system hosted by a company network (such as company network 102 shown in FIG. 1), such as when the IOT infrastructure sends an unlock command to the PLC to unlock one of the lock boxes 210 based on a monitored condition of another connected device in the IOT infrastructure.

The above described system and lock box thus facilitate integration of legacy lockable articles with a tool control system. A method for integrating the legacy lockable articles with a tool control system will now be described with reference to FIGS. 1-4.

Where there are a plurality of legacy lockable articles 108 at a facility or across multiple associated facilities, the method first comprises providing a lock box (e.g., lock box 110 or lock box 210 as discussed above) associated with a respective legacy lockable articles 108. Each lock box 110 is operable to control key access to each of the respective legacy lockable articles 108. In this example, a key for each respective legacy lockable article 108 can be attached to a key holder 250. The key holder 250 can be selectively lockable to the lockbox body 220 of respective lock boxes 210 via the actuatable lock 240. The actuatable lock 240 can be a linear actuator comprising a shaft 240 that is inserted into a corresponding lock interface 260 of the key holder 250 (e.g., one defined by a cylindrical aperture) to lock the key holder 250 to the lock box body 220 and that is removed from the lock interface 260 to unlock the key holder 250 from the lock box body 220.

The method further comprises receiving a lock/unlock status from the plurality of lock boxes 110, 210 at the PLC 112. The PLC 112 is connected to the plurality of lock boxes 110, 210, such as via a remote I/O device 114. The PLC 112 can send the status of each lock box 110, 210 to an IOT infrastructure 116, such as to an IOT server forming part of the IOT infrastructure 116 that is communicatively coupled to the PLC 112. The IOT infrastructure 116 can thus track a status of each lock box 110, 210 including whether the lock box 110, 210 is locked or unlocked, or whether a key sensor 246 detects the presence or absence of the key holder 250 at the lock box 110, 210.

When a user requires a tool, chemical, or other object or substance stored in or at a legacy lockable article 108, control instructions can be received from the user via the human machine interface 104 to unlock the lock box 110, 210 associated with the legacy lockable article 108. Or, alternatively, when a user is finished with a tool, chemical, or other object or substance and that object or substance is returned to the legacy lockable article 108, control instructions can be received from the user via the human machine interface 104 to lock the lock box 110, 210 associated with the legacy lockable article 108.

The control instructions can be validated at an IOT server of an IOT infrastructure 116 prior to sending the instructions to the lock box 110, 210. For example, the human machine interface 104 can validate a user profile via user identifying information (such as via biometrics, a password, an access card, etc.) via a company network 102 and send validated instructions to the internet of things server of IOT infrastructure 116. The validation can be based on whether the user profile has sufficient access rights to access the lock box 110, 210 at the requested time. The IOT server of an IOT infrastructure 116 can forward the validated control instructions to the PLC 112, and the PLC 112 can send a lock or unlock command to the specified lock box 110 based on the control instructions.

method can further comprise monitoring the status of the lock boxes 110, 210. For example, the PLC 112 can receive an indication from one or more of the lock boxes 110, 210 regarding the removal of a key holder 250 and associated key from the lock box 110, 210 based on feedback from the key sensor 246. Similarly, the PLC 112 can receive an indication from one or more of the lock boxes 110, 210 regarding the return of a key holder 250 and associated key from the lock box 110, 210 based on feedback from the key sensor 246. In this manner, the system can track the removal and return of keys and can associate the events with one or more user profiles and with one or more tools or substances to be removed from the legacy lockable article in accordance with a procedure stored in the manufacturing database 106.

The method can further comprise receiving an indication that the key holder 250 and associated key has been removed for a predetermined time period. The method can be set to ensure that a legacy lockable article 108 is not left unlocked allowing unregulated access. Thus, the system can track whether a key has been removed for certain time period at which an indication is sent to the PLC 112 so that corrective measures can be taken. It is noted that the indication can originate from a lock box 110, 210, the PLC 112, or the IOT infrastructure 116 as desired. As mentioned above, the visual indicators 232, 234 at the lock box 210 can be operable to provide visual feedback corresponding to the above mentioned indications.

The system and method set forth in the disclosure provides several advantages. For example, by controlling key access using the above described system, method, and lock box, contents such as tools, chemicals, or other substances can be integrated into a regulated, tool control system. Safeguards to unregulated access of legacy lockable articles can be controlled based on the feedback from the lock boxes to the system. The feedback can include a locked and unlocked status of the lock boxes and a detection of the key within the lock boxes. This can also include indications of when a key is removed for longer than a predetermined time period. Further, each event can be associated with a user profile providing accountability to those using the system.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Although the disclosure may not expressly disclose that some embodiments or features described herein may be combined with other embodiments or features described herein, this disclosure should be read to describe any such combinations that would be practicable by one of ordinary skill in the art. The use of “or” in this disclosure should be understood to mean non-exclusive or, i.e., “and/or,” unless otherwise indicated herein.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A system for integrating key access control of a plurality of legacy lockable articles into a tool control system, the system comprising:
a plurality of lock boxes each associated with a respective legacy lockable article, each of the plurality of lock boxes configured to selectively lock and unlock access to a key operable to facilitate access to the respective legacy lockable article;
a programmable logic controller communicatively coupled to each of the plurality of lock boxes, the programmable logic controller operable to send control instructions to the plurality of lock boxes to lock or unlock access to the key;
a human machine interface communicatively coupled to the programmable logic controller, the human machine interface in communication with one or more processors and a memory, and operable to receive user instructions to lock or unlock the one or more lock boxes; and
an internet of things server communicatively coupled to the programmable logic controller and the human machine interface, the internet of things server configured to receive an unlock or locked status for each of the one or more lockboxes from the programmable logic controller and to send unlock or lock commands to the programmable logic controller based on one or more predetermined conditions.

2. The system of claim 1, wherein each of the plurality of lock boxes comprises a lock box body comprising a mount to attach the lock box body to the respective legacy lockable article, the mount being accessible from inside a locked portion of the legacy lockable article.

3. The system of claim 2, wherein each of the plurality of lock boxes comprises a key holder comprising a key interface for securing a key to the key holder, and a lock interface for facilitating locking of the key holder to the lock box body.

4. The system of claim 3, wherein each of the plurality of lock boxes comprises an access opening in the lock box body configured to receive the key holder, and an actuatable lock disposed within the lock box body operable to interface with the lock interface of the key holder to lock the key holder to the lock box body based on the control instructions received from the programmable logic controller.

5. A tamper proof lock box associated with a legacy lockable article for facilitating integration of the legacy lockable article into a tool control system, the tamper proof lock box comprising:
a lock box body comprising a mount to attach the lock box body to an external structure;
a data port disposed on the lock box body, the data port communicatively coupled to a programmable logic controller;
a key holder comprising a key interface for securing a key to the key holder, and a lock interface for facilitating locking of the key holder to the lock box body;
an access opening configured to receive the key holder; and
an actuatable lock disposed within the lock box body, and operable to interface with the lock interface of the key holder to lock the key holder to the lock box body.

6. The tamper proof lock box of claim 5, wherein the actuatable lock comprises a linear actuator operable to interface with the lock interface of the key holder to lock the key holder to the lock box body.

7. The tamper proof lock box of claim 6, wherein the lock interface comprises an aperture, and the linear actuator comprises a shaft that extends through the aperture to lock the key holder to the lock box body.

8. The tamper proof lock box of claim 6, wherein the access opening comprises a slot in the lock box body, and the linear actuator is oriented transverse to the slot.

9. The tamper proof lock box of claim 5, further comprising a key sensor operable to detect the presence of the key holder at the lock box.

10. The tamper proof lock box of claim 9, wherein the key sensor comprises an inductive proximity sensor.

11. The tamper proof lock box of claim 5, further comprising one or more visual indicators disposed on the lock box body, the one or more visual indicators operable to communicate a status of the key holder.

12. The tamper proof lock box of claim 11 the one or more visual indicators comprising LEDs.

13. A method for integrating key access control of a plurality of legacy lockable articles in a tool control system, the method comprising:
providing a plurality of lock boxes, each associated with a respective legacy lockable article, each of the plurality of lock boxes configured to selectively lock and unlock access to a key operable to facilitate access to the respective legacy lockable article;
receiving a lock/unlock status from the plurality of lock boxes at a programmable logic controller communicatively coupled to each of the plurality of lock boxes;
sending a lock/unlock status from the programmable logic controller to an internet of things server communicatively coupled with the programmable logic controller;
receiving control instructions at a human machine interface communicatively coupled to the internet of things server to lock or unlock access to the key at a first lock box of the plurality of lock boxes and sending the control instructions to the internet of things server;
validating the control instructions at the internet of things server and sending the control instructions to the programmable logic controller; and
sending a lock or unlock command from the programmable logic controller based on the control instructions to the first lock box.

14. The method of claim 13, further comprising receiving a first indication at the programmable logic controller that the key is removed from the lock box based on an output from a key sensor of the first lock box.

15. The method of claim 14, further comprising receiving a second indication at the programmable logic controller that the key is returned to the lock box based on the output from the key sensor of the first lock box.

16. The method of claim 15, further comprising receiving a third indication at the programmable logic controller that the key is removed from the lock box for a predetermined time period.

17. The method of claim 16, further comprising displaying a key status at the lock box based on the first, second, and third indications via one or more visual indicators.

18. The method of claim 13, further comprising attaching the key to a key holder, the plurality of lock boxes configured to selectively lock and unlock the key holder.

19. The method of claim 18, wherein the plurality of lock boxes selectively lock and unlock the key holder via a linear actuator disposed at each of the plurality of lock boxes.

20. The method of claim 19, wherein the linear actuator locks the key holder to the lock box via a shaft that extends through a corresponding aperture of the key holder.
